(19) United States
(12) Patent Application Publication
(10) Pub. No.: US 2006/0017877 A1
(43) Pub. Date: Jan. 26, 2006

(54) ODF type method for manufacturing an LCD

(75) Inventor: Jia-Yi Wu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/188,593

(22) Filed: Jul. 25, 2005

(30) Foreign Application Priority Data
Jul. 23, 2004 (TW) 93122075

(51) Int. Cl. G02F 1/13

(52) U.S. Cl. 349/187

(57) ABSTRACT

An ODF type method for manufacturing an LCD in accordance with one preferred embodiment of the present invention includes the following steps: firstly, providing a first substrate with a display area, and a second substrate; secondly, forming a sealant on the first substrate, the sealant enclosing the display area; thirdly, spraying spacers onto the second substrate; measuring a distance between the sealant and display area, and measuring a density of the spacers, and determining an optimum quantity of liquid crystal material; and finally, dispensing the optimum quantity of liquid crystal material on the first substrate. Thus, an optimum quantity of liquid crystals can be dispensed.

### BACKGROUND OF THE INVENTION

1. Field of the Invention

The present invention relates to a liquid crystal display (LCD) panel, and especially to an LCD panel manufactured by a one-drop-fill (ODF) type method.

2. Description of the Related Art

An LCD cell generally comprises two glass substrates, a peripheral sealant, a plurality of spacers, and a plurality of liquid crystal molecules retained in a space defined between the substrates and the sealant.

The sealant is first printed on one of the glass substrates; and then the glass substrate is adhered to the other glass substrate. The substrates and the sealant cooperatively form the space therebetween, and then the liquid crystal molecules are filled into the space. The spacers are for keeping a consistent cell gap between the opposite glass substrates. In general, the spacers are provided by either of the following two methods. In one method, the spacers are in the form of spherical particles, which are sprayed on the surfaces of the substrates. In the other method, the spacers are columnar instead of being spherical particles. The columnar spacers are formed on either or both of the glass substrates opposite to each other.

There are generally two methods used for filling the liquid crystal molecules into the space between the substrates and the sealant. Referring to FIG. 4, in the first method, liquid crystal molecules 108 are filled through filling ports 106. The first method includes the following steps: firstly, printing a sealant 104 on a first glass substrate 102, wherein the sealant 104 is rectangular and has one or more gaps that function as filling ports 106; secondly, combining a second glass substrate (not shown) with the first glass substrate 102 and curing the sealant 104, wherein a space is enclosed by the sealant 104 and the two glass substrates; thirdly, immersing the filling ports 106 in a bath of liquid crystal material 108 in a vacuum chamber; and finally, introducing gas into the vacuum chamber to make the liquid crystal molecules 108 fill up the space.

The second method is the so-called one-drop-fill (ODF) method. Stages in a typical ODF method are shown from FIG. 5 through FIG. 7. The second method includes the following steps: firstly, printing a sealant 64 on a first glass substrate 66, wherein the sealant 64 is rectangular and continuous, and a space is defined between the sealant 64 and the first glass substrate 66; and spraying spacers 65 on a second glass substrate 60 (FIG. 5); secondly, dispensing liquid crystal molecules 62 on the first glass substrate 60 drop by drop using a dispenser (not shown) (FIG. 6); and finally, combining the second glass substrate 60 with the first glass substrate 66, and curing the sealant 64 using ultraviolet (UV) light 72 emitted by an ultraviolet light source 70, the ultraviolet light source 70 being progressively moved along a path 68 corresponding to the location of the sealant 64 (FIG. 7). The ODF method also needs to be performed in a vacuum, at least at the time when the substrates are combined.

According to the ODF method, a predetermined quantity of liquid crystals is dispensed into the space using the dispenser. However, once the substrates are combined together, the quantity of liquid crystals filled between the substrates may be excessive or insufficient. This can occur due to inaccurate dispensing by the dispenser, or because of variations in the cell gap between the substrates.

When columnar spacers are used for maintaining the cell gap between the substrates, the columnar spacers are generally made of a resin. In mass production, the columnar spacers having a height of several microns are formed on substrates of numerous LCD panels, and the height of the columnar spacers is prone to vary from substrate to substrate. This means that the cell gap between the opposite glass substrates may vary from LCD panel to LCD panel. Thus, the quantity of liquid crystals filled between the combined substrates may be excessive in some LCD panels, and may be insufficient in other LCD panels. An insufficient quantity of filled liquid crystals results in so-called foams. An excessive quantity of filled liquid crystals can result in an irregular display. Any LCD panel having such foams or an irregular display is regarded as defective.

When spacers in form of spherical particles are used for maintaining the cell gap between the substrates, the spacers are sprayed on either or both of the substrates. Generally, the spherical particles have substantially the same size. However, in mass production, the number of spacers sprayed on substrates of numerous LCD panels is prone to vary from substrate to substrate. That is, the density of sprayed spacers may vary from substrate to substrate. Accordingly, the quantity of liquid crystals filled between the two substrates may vary from LCD panel to LCD panel. Thus the LCD panels may not provide consistent display performance.

In a typical ODF method, the height of the columnar spacers can be measured, and an optimum quantity of liquid crystals to be dispensed can be calculated according to such measurement. When spacers in form of spherical particles are sprayed onto the substrate, the density of the spacers can be inspected and measured, and the optimum quantity of liquid crystals to be dispensed can be calculated according to such measurement. However, in general, other conditions that may influence the optimum quantity of liquid crystals are not taken into account. For example, the distance between the sealant and a display area is one such condition. This limits the accuracy of the calculated optimum quantity of liquid crystals filled between the substrates.

It is desired to provide an ODF type method for manufacturing an LCD, in which the method overcomes the above-described deficiencies.

### SUMMARY

An ODF type method for manufacturing an LCD in accordance with one preferred embodiment of the present invention includes the following steps: firstly, providing a first substrate with a display area, and a second substrate; secondly, forming a sealant on the first substrate, the sealant enclosing the display area; thirdly, spraying spacers onto the second substrate; measuring a distance between the sealant and display area, and measuring a density of the spacers, and determining an optimum quantity of liquid crystal material; and finally, dispensing the optimum quantity of liquid crystal material on the first substrate.

The distance between the sealant and the display area can be measured, and an optimum quantity of liquid crystals can be dispensed based on the inspected value. When spacers having form of spherical particles are sprayed, the density of the spacers can be inspected to decide an optimum quantity of liquid crystals based on the same. Thus, an optimum quantity of liquid crystals can be dispensed.

Other advantages and novel features will become more apparent from the following detailed description when taken in conjunction with the accompanying drawings, in which:

### BRIEF DESCRIPTION OF THE DRAWINGS

FIG. 1 is a flow diagram of an ODF type method for manufacturing an LCD according to a preferred embodiment of the invention;

FIG. 2 and FIG. 3 are plan views of two different substrates respectively, showing two stages of the ODF type method of FIG. 1;

FIG. 4 is a schematic, cross-sectional view of an LCD panel being filled with liquid crystal molecules through filling ports, according to one kind of typical method for manufacturing an LCD panel;

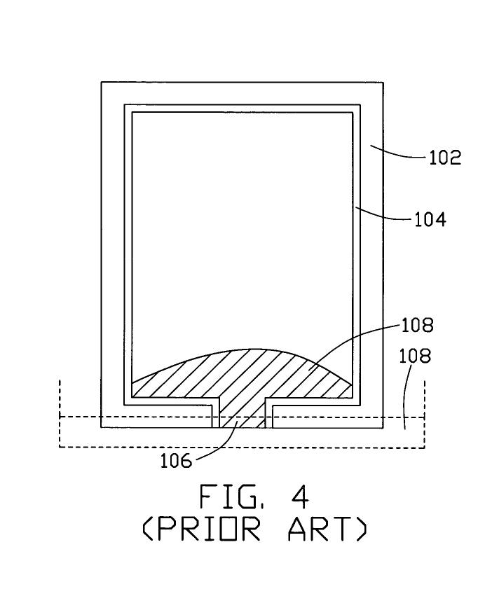

FIGS. 5 through 7 are schematic, simplified isometric views showing stages of a typical ODF method for manufacturing an LCD panel.

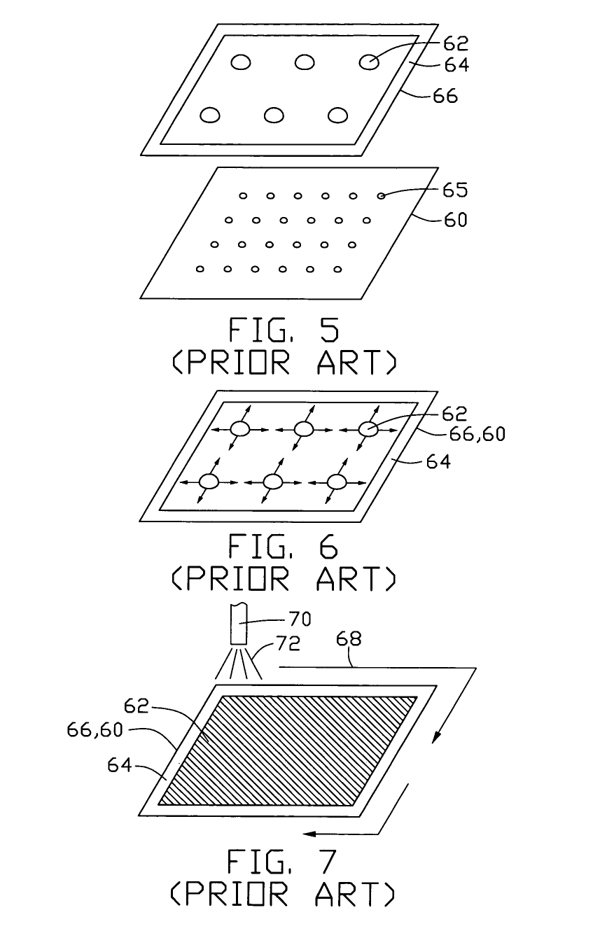

### DETAILED DESCRIPTION OF THE EMBODIMENT

Reference will now be made to the drawings to describe the present invention in detail.

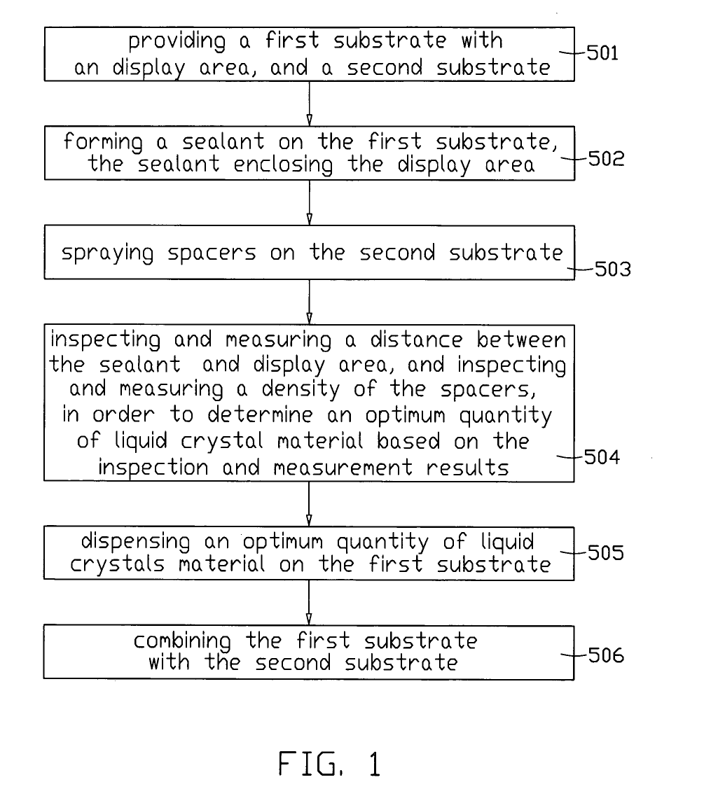

FIGS. 1-3 illustrate an ODF type method for manufacturing an LCD according to a preferred embodiment of the present invention. The method includes the following steps: step 501, providing a first substrate with a display area, and a second substrate; step 502, forming a sealant on the first substrate, the sealant enclosing the display area; step 503, spraying spacers on the second substrate; step 504, inspecting and measuring a distance between the sealant and display area, and inspecting and measuring a density of the spacers, in order to determine an optimum quantity of liquid crystal material based on the inspection and measurement results; step 505, filling the optimum quantity of liquid crystal material on the first substrate; and step 506, combining the first substrate with the second substrate.

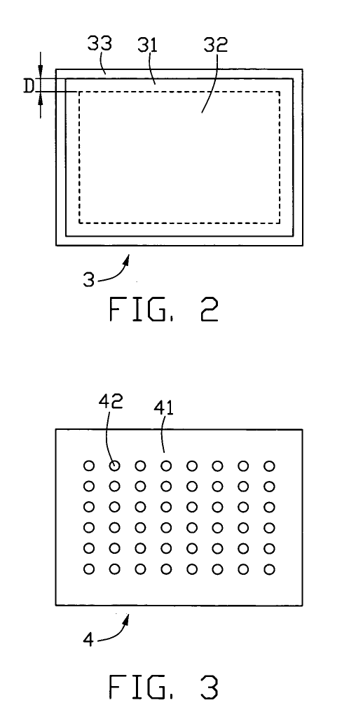

Referring to FIG. 2, in step 501, a first substrate 3 is typically a color filter (CF) substrate, which defines a display area 32 used to display images thereon. Generally, the display area 32 is rectangular, and an area of the display area 32 is less than that of the first substrate 3. The second substrate 4 is typically an array substrate, having switching elements such as TFTs formed thereon.

In step 502, the sealant 33 is printed on an inner surface 31 of the first substrate 3, around the display area 32. The sealant 33 is typically an ultraviolet-curable sealant, and is cured when it is irradiated with ultraviolet (UV) rays. There is a distance D defined between the sealant 33 and the display area 31.

Referring to FIG. 3, in step 503, a plurality of spacers 42 in the form of spherical particles are uniformly sprayed onto a surface 41 of the second substrate 4. The spacers 42 are cured under pre-baking conditions, and used for maintaining a constant cell gap (cell thickness) between the two opposite substrates 3, 4.

Referring to FIGS. 2 and 3, in step 504, the distance D between the sealant 33 and the display area 32 is inspected and measured by an inspecting device (not shown), and a density of the spacers 42 is inspected and measured by another inspecting device (not shown). The optimum volume of liquid crystal material is calculated according to the following formula: V_{1c}=(S₁+S₂)*H−V₃. In this formula: V_{1C} is the volume of the liquid crystal material; S₁ is the area of the display area 32; S₂ is an area defined between the display area 32 and the sealant 33; H is the distance between the first substrate 3 and the second substrate 4; and V₃ is the volume of the spacers 42, which can be calculated according to the density of the spacers 42.

An optimum weight of the liquid crystal material can be calculated according to the following formula: W_{1c}=V_{1c}*D_{1c}. In this formula, W_{1c} is the weight of the liquid crystal material, V_{1c} is the volume of the liquid crystal material; and D_{1c} is the density of the liquid crystal material.

In step 505, a dispenser (not shown) is used for dispensing the optimum quantity of liquid crystal material on the first substrate 3.

In step 506: the process of combining the first substrate 3 with the second substrate 4 needs to be performed in a vacuum. Afterward, the combined substrates 3, 4 are returned to normal room pressure conditions. Under such conditions, the liquid crystal material between the first substrate 3 and second substrate 4 spreads slightly and reaches an operational state. Finally, a UV light source is moved along a path corresponding to the sealant 33, and irradiates UV light in order to cure the sealant 33.

Unlike in a conventional method, in the above-described method, the distance between the sealant and the display area can be inspected and measured, and the density of the spacers can be inspected and measured. Thus the optimum quantity of liquid crystal material can be accurately determined, based on the measurement results. A highly accurate optimum quantity of liquid crystal material in each liquid crystal display panel can help eliminate so-called foams attributable to an insufficiency of liquid crystal material, and can help eliminate display irregularity attributable to an excessive quantity of liquid crystals.

It is to be understood, however, that even though numerous characteristics and advantages of the preferred embodiments and the present invention have been set out in the foregoing description, together with details of the structures and functions of the embodiments and the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing an LCD (liquid crystal display), comprising the following steps:
(a) providing a first substrate with a display area, and a second substrate;
(b) forming a sealant on the first substrate, the sealant enclosing the display area;
(c) spraying spacers onto the second substrate;
(d) measuring a distance between the sealant and display area, and measuring a density of the spacers, and determining an optimum quantity of liquid crystal material; and
(e) dispensing the optimum quantity of liquid crystal material on the first substrate.

2. The method for manufacturing an LCD as claimed in claim 1, wherein the optimum quantity of liquid crystal material is determined according to the formula: V_{1c}=(S₁+S₂)*H−V₃; wherein V_{1c} is the volume of the liquid crystal material; S₁ is the area of the display area; S₂ is the area between the display area and the sealant; H is the distance between the first substrate and the second substrate; and V₃ is the volume of the spacers, which is determined according to a density of the spacers.

3. The method for manufacturing an LCD as claimed in claim 2, further comprising calculating an optimum weight of the liquid crystal material, according to the formula: W_{1c}=V_{1c}*D₁c; wherein W_{1c} is the weight of the liquid crystal material, V_{1c} is the volume of the liquid crystal material, and D_{1c} is the density of the liquid crystal material.

4. The method for manufacturing an LCD as claimed in claim 1, further comprising the following step:
(f) combining the first substrate with the second substrate in a vacuum.

5. The method for manufacturing an LCD as claimed in claim 4, further comprising the following step:
(g) irradiating the sealant with UV (ultraviolet) light in order to cure the sealant.

6. A method of making an LCD comprising the steps of:
(a) providing a first substrate with a display area, and a second substrate;
(b) forming a sealant on the first substrate, the sealant enclosing the display area;
(c) applying spacers onto the second substrate;
(d) determining an optimum quantity of liquid crystal material by relation of a distance between the sealant and the display area, and a density of the spacers; and
(e) applying the optimum quantity of liquid crystal material on the first substrate.
